(19) United States
(12) Patent Application Publication
(10) Pub. No.: US 2006/0116778 A1
(43) Pub. Date: Jun. 1, 2006

(54) On-line statistical process control information system and method

(75) Inventors: Tien-Hua Chiang, Zhudong Town (TW); Yi-Yi Huang, Taipei City (TW); Tsu-Kuang Yang, Wuqi Town (TW)

Correspondence Address: BRUCE H. TROXELL;SUITE 1404, 5205 LEESBURG PIKE, FALLS CHURCH, VA, 22041, US

(73) Assignee: Industrial Technology Research Institute

(21) Appl. No.: 11/086,342

(22) Filed: Mar. 23, 2005

(30) Foreign Application Priority Data
Nov. 26, 2004 (TW) 93136400

(51) Int. Cl. G05B 13/02; G06F 17/18; G06F 19/00; G06F 15/00

(52) U.S. Cl. 700/51; 700/50; 700/28; 702/179; 702/180; 702/181

(57) ABSTRACT

On-line statistical process control information system and method are disclosed, which are particularly related to system and method of real-time reflecting and controlling quality of a manufacturing process by employing a database and computer network technology. With the system and method of on-line statistical process control information, information associated with each inspection lot (e.g. the associated clients, products, equipment and the like) input by inspectors is corresponded automatically to respective control charts. Meanwhile, historical data associated with the control charts are acquired to be determined if any exception is occurred by referring to criterions associated therewith. When an exception is determined to be present, a notification is issued real time to an associated operator such as by sending an email to the operator. As such, the quality of the on-line products may be real time reflected, time for defining the control charts by quality control engineers is reduced, also, time for searching large amounts of control charts by inspector is reduced, and quality analyses of the products with respect to a multitude of screening combinations may be conducted by the quality control engineers based on the information associated with the involved inspection lots. Therefore, any problem taken place in the manufacturing process may be located rapidly and a solution thereof may correspondingly be addressed rapidly.

### FIELD OF INVENTION

The present invention pertains to on-line statistical process control information system and method with respect to on-line products in a manufacturing process, by which information associated with each inspection lot (e.g. the associated clients, products, equipment and the like) input by inspectors is corresponded automatically to respective control charts, historical data associated with the control charts are acquired to be determined if any exception is occurred so that quality of the on-line products can be real time reflected, also, time for defining the control charts by quality control engineers is reduced and quality analyses of the products with respect to a multitude of screening combinations may be conducted by the quality control engineers based on the information associated with the involved inspection lots and, thus any problem taken place in the manufacturing process may be located rapidly and a solution thereof may correspondingly be addressed rapidly.

### BACKGROUND OF THE INVENTION

Statistical Process Control (SPC) Chart is a tool most frequently employed for monitoring the quality of a manufacturing process. Statistical Process Control is a process of real-time monitoring a manufacturing process, where random variations and assignable-cause variations are determined and separated with respect to the quality and quantity of the product obtained in the manufacturing process based on statistical analysis technology. In this manner, any specific exceptional tendency taken place in the manufacturing process may be located and issued in such a manner that the exceptional tendency may be known by an operator of the manufacturing process so that the operator may take a measure thereon real time so as to eliminate the exception and restore the manufacturing process back to normal. As such, the purpose of control and enhancement of the quality and quantity of the on-line product may be achieved.

SPC is means for controlling a process with an aid of mathematics and statistics. Specifically, SPC analyzes and evaluates a manufacturing process with respect to the products involved therein so that symptom of assignable-cause variations may be detected real time based on feedback information obtained in the manufacturing process, and effect brought by the assignable-cause variations may be eliminated by appropriate measures. Since the manufacturing process may be controlled under a condition that the process only suffers an effect brought by the random variations, the purpose of control of the on-line products is well achieved. In the case that the process only suffers the effects brought by the random variations, the process is statistically controlled (in a controlled state). In contrast, if the process has assignable-cause variations existed, the process loses statistical control (in an uncontrolled state). Since the variations occurred in the process corresponds to a specific regularity, characteristics associated with the process is in compliance with a specific stable random distribution when the process is in the controlled state while the distribution associated with the process varies when the process is in the uncontrolled state. Based on the statistical regularity in relation to the variations as mentioned, SPC may analyze the process statistically. Since the process may operate under the controlled state, the product and service associated with the manufacturing process may satisfy demand from customers.

SPC has the following particular benefits: (1) It may guarantee prevention of any exception in the whole process by monitoring and participating in the whole process based on scientific methods, particularly the statistical technology. (2) SPC may not only be applied in control of quality and quantity of on-line products but may also be applied in any management process. (3) Since SPC is established based on the spirit of involvement in the whole manufacturing process, execution of SPC may put actual prevention and control into realization beforehand and thus satisfy the requirements of quality and quantity of the on-line product in the manufacturing process.

Today, diversities and a number of production environments are involved with respect to manufacturing of specific products in, such as, semiconductor, liquid crystal display (LCD) industries, and hence up to hundreds or even thousands of control charts for each individual quality control item in the manufacturing process are required. Consequently, for all the quality control items required for manufacturing of the product, number of the corresponding control charts as necessary may amount to several ten thousands. No matter if these control charts are built up by plotting manually thereon or by establishing a single electronic file corresponding thereto, it is difficult for inspection staffs involved in the production line associated with the products to locate in a short time a desired proper control chart among the control charts beyond ten thousands involved with the production for input and management of inspection data obtained in a preceding stage. Further, each of the ten thousands of control charts have to be set with desired specific control conditions and control rules and which poses a heavy load for quality control engineers. In this regard, fineness of the control charts has necessity of being simplified to reduce the number of the control charts and the operation time as necessary. However, this would otherwise lead to a difficulty for locating pertinent causes in a particular exception taken place in the manufacturing process due to the insufficient fineness of the control charts. In this case, it is impossible to set forth a proper real time measure for the exception.

To settle down this problem as aforementioned, the present invention sets forth on-line statistical process control information system and method with respect to specific on-line products, in which mechanism of automatic delaminating and corresponding of the inspection values to the control charts is aroused and facilitate management of the control charts involved with the manufacturing process of the on-line products, thereby solving the fineness issue of the control charts resulted from the simplified control charts and thus the reduced number of control charts. In addition, the system also provides functions of further screening of the control charts and delaminating analysis, which may efficiently promote the quality of the on-line products.

### SUMMARY OF THE INVENTION

It is, therefore, an object of the present invention to provide on-line statistical process control information system and method in a manufacturing process of products in which quality control information is collected rapidly from a plurality of inspection workstation involved in a production line by an on-line data collection module and through a connection with a computer network, and the collected information is analyzed and processed for management purpose, considerably enhancing efficiency and accuracy of the quality of the controlled products.

It is another object of the present invention to provide on-line statistical process control information system and method used in a manufacturing process of products in which a mechanism of automatically delaminating and corresponding inspection values obtained previously to control charts as needed for the manufacturing process may facilitate management of the control charts and solve a fineness issue of the control charts resulted from the simplified control charts and thus reduced number of the control charts. In addition, the system also provides functions of further screening of the control charts and delaminating analyses, which may efficiently promote the quality of the on-line products.

### BRIEF DESCRIPTION OF THE DRAWINGS

The invention will become more fully understood from the detailed description given herein below illustration only, and thus are not limitative of the present invention, and wherein:

FIG. 1 is a schematic diagram of an architecture of an on-line statistical process control information system according to the present invention;

FIGS. 2A & 2B are schematic diagrams describing a relationship among individual functional modules of the on-line statistical process control information system according to the present invention;

FIG. 3 is a flowchart describing a method of setting up a portion of quality control data in a data setup module of the on-line statistical process control information system according to the present invention; and FIG. 4 is a flowchart describing a method of automatically collecting inspection information and corresponding to control charts according to the present invention.

### DETAILED DESCRIPTION OF THE INVENTION

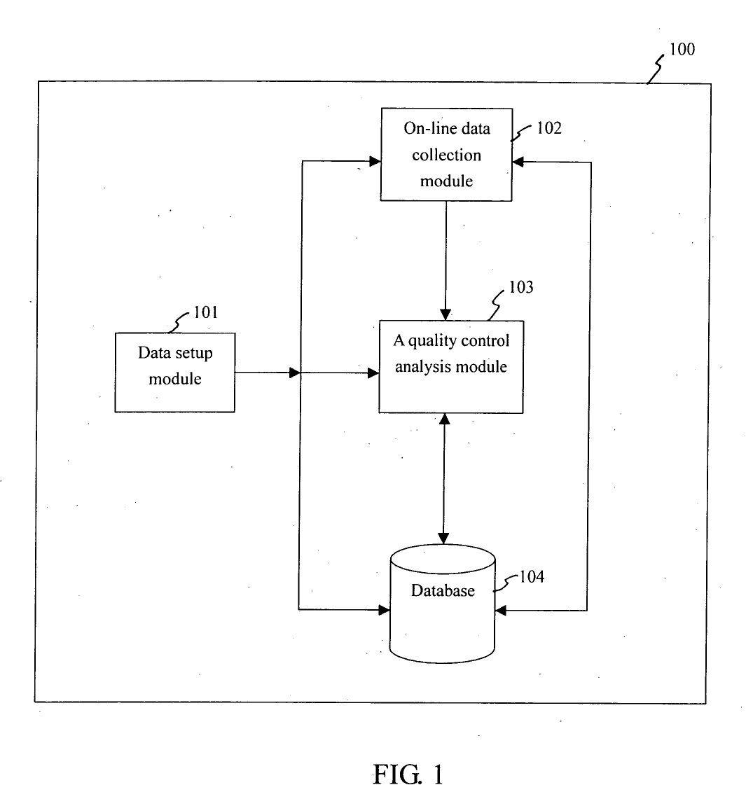

Referring to FIG. 1, a schematic diagram of an architecture of on-line statistical process control information system used in a manufacturing process according to the present invention is illustrated therein. As may be known from FIG. 1, the on-line statistical process control information system 100 comprises a data setup module 101 used for setting data of kinds desired, an on-line data collection module 102 configured for collecting quality control data from a plurality of inspection workstations involved in the manufacturing process through a connection with a computer network, a quality control and analysis module 103 adapted to analyze the collected quality control information and a database 104 used for storing data therein. With regard to the data setup module 101, it mainly focuses on setting the data of kinds desired as noted above. The data of kinds desired comprises data associated with clients, suppliers, staffs, product, equipment, user authorization information, definitions of lot factors, inspection history, quality control items, defective cause code, cause code corresponding setting, the relationship between quality control items and lot factors, inspection workstations, product specifications, rules of control charts, control content, acceptable quality level (AQL,) sampling plan and the like. As to the on-line data collection module 102, it collects real time the on-line quality control data from the inspection workstations involved in the manufacturing process through the network as noted above (the corresponding inspection values may alternatively or additionally be input by on-line). The collected on-line quality control data may comprise data associated with quality control estimation, quality control counting, notification of exception occurred in the on-line quality control and the like. With respect to the quality control analysis module 103, it mainly functions to analyze the quality control information as noted above. Specifically, the module 103 may query and process the inspection information, analyze the data collected by the on-line data collection module. Concerning the database 104, it is essentially used for storing data therein as noted above. The stored data may comprise the as-set data of kinds, the analyzed quality control data and at least a group of data associated with the quality control charts.

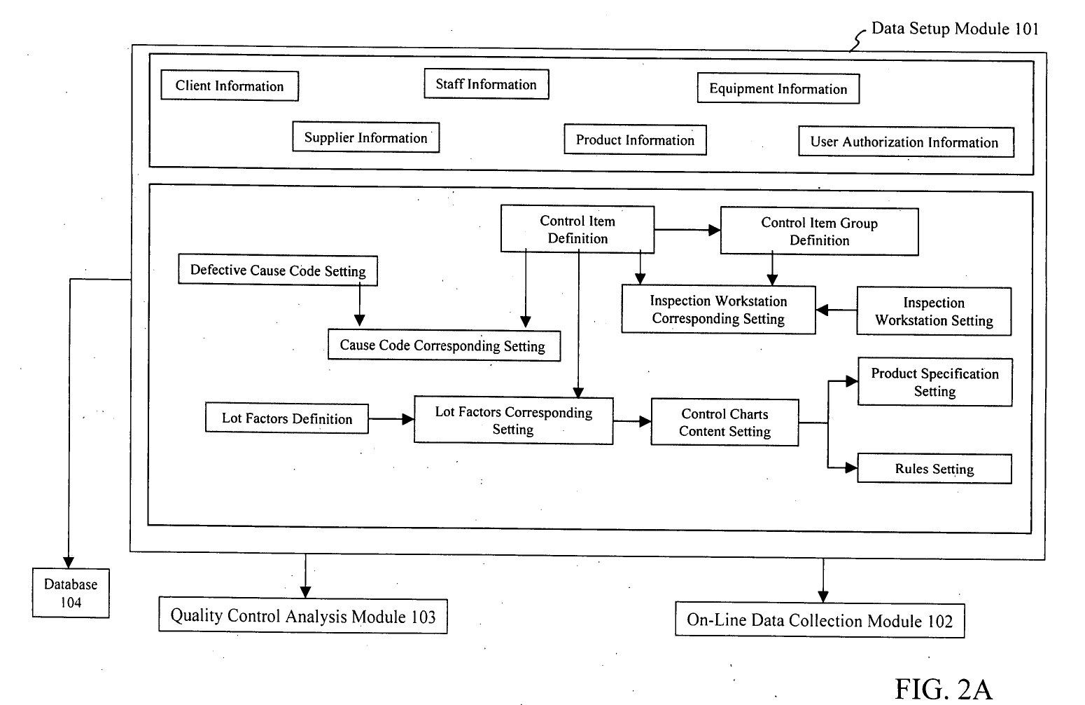

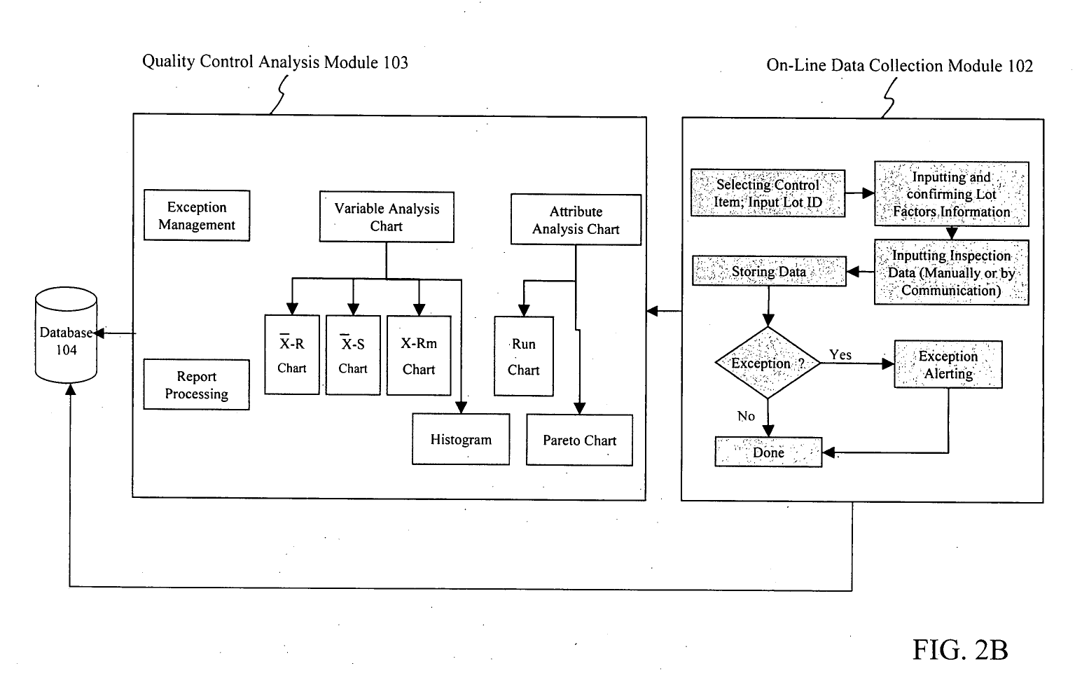

Reference is made to FIGS. 2A & 2B (referenced as a whole), a schematic diagram describing a relationship among individual functional modules of the on-line statistical process control information system used in a manufacturing process according to the present invention is depicted therein. As shown, a specific connection among a data setup module 101, an on-line data collection module 102, a quality control analysis module 103 and a database 104 of the on-line statistical process control information system is presented.

A statistical process control information method used in a manufacturing process according to the present invention, which is embodied in a platform provided by the system of the invention as described above, may be roughly divided into two stages. The first stage is to set up quality control data in the data setup module of the on-line statistical process control information system. The second is to automatically delaminate and correspond inspection values obtained from production line to control charts as needed for the manufacturing process.

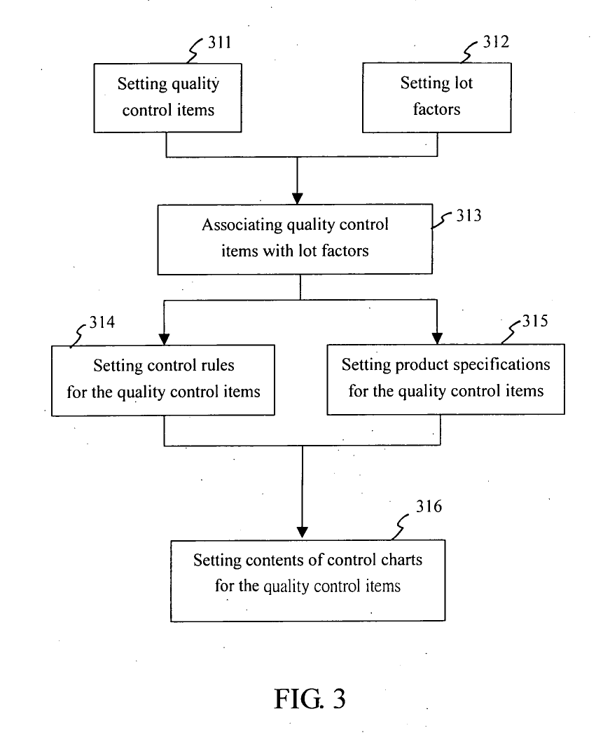

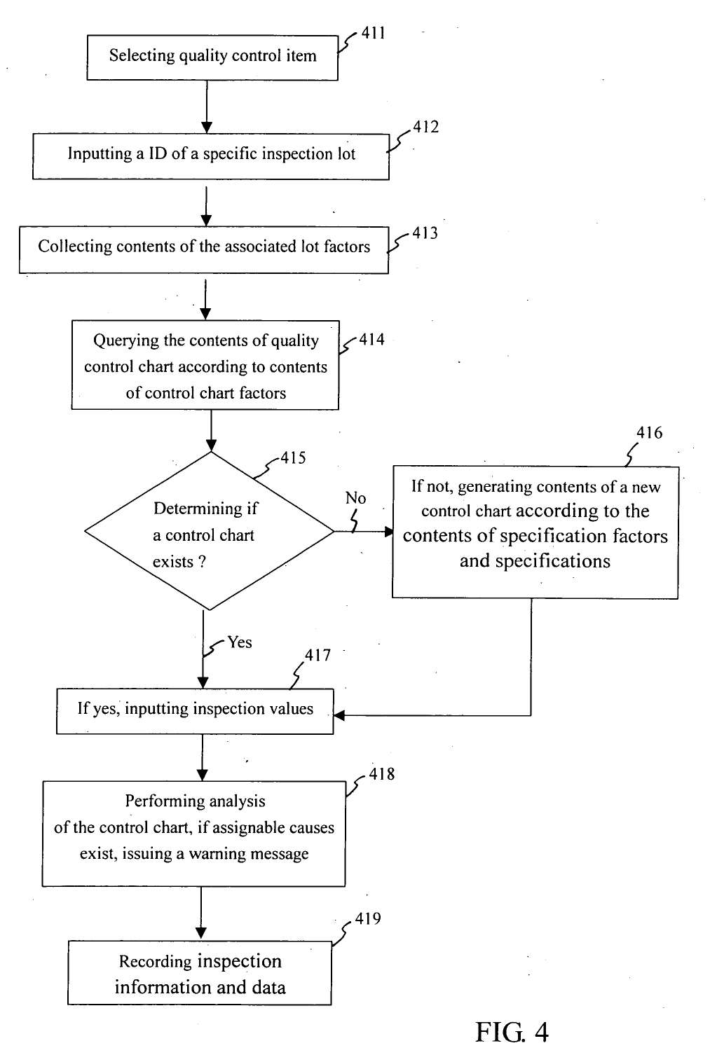

Referring now to FIG. 3, a method of setting up a portion of the quality control data in the data setup module of the on-line statistical process control information system used in a manufacturing process according to the present invention is described therein. As may be known from FIG. 3, a process of setting up the portion of the quality control data in the data setup module may comprise the following steps:

Step 311: Setting quality control items;

Step 312: Setting lot factors;

Step 313: Setting associates of lot factors of the quality control items;

Step 314: Setting control rules for the quality control items;

Step 315: Setting product specifications for the quality control items; and

Step 316: Setting contents of control charts for the quality control items, and the contents contain the control items, specifications, and etc.

In Step 313 as noted above, the lot factors for the quality control items comprise general factors, control chart factors and specifications factors. The control chart factor is the subset of the general factor and the specifications factor is the subset of the control chart factor. In practices, for a specific control item, a plaurality of general factors are setup to associate with that item, and then control chart factors and specifications factors in sequence. During the on-line quality control process, the on-line quality control inspector will input all the general factors associated with a certain specific product lot collected from the production line, the system of the present invention will retrieve the corresponding control chart associated with the control chart factors which is the subset of the general factors and is setup preciously. If no such control chart can be found, the system will create a new one according to the specifications factors which is the subset of the control chart factors. The data associated with the general factors comprises the information of products, clients, equipments, staffs and the like. More details, part of the general factors is related to the control chart factors. The system of the present invention uses the value of control chart factors collected from on-line to determine a corresponding control chart or, when there is no certain chart that is associated, to create a new control chart. Since the specifications factor is the subset of the control charts factors, which is also one of the vectors to determine whether create a new control chart or not. The control chart factors comprises the information of products, clients, equipments and the data associated with specifications factors comprises the information associated with products, clients and the like. In step 315, data associated with the product specifications for the quality control items comprises upper-limit and lower-limit specification setup according to different specifications, for example, such as (a) product A & client 1: US 52, LS 18, (b) product A & client 2: US 55, LS 16 and (c) product B & client 1: US 83, LS 37.

In step 316, the quality control staffs setup the control chart contents for each control charts according to the specific control items, and the data related to control chart contents for the control items comprises data associated with automatic delaminated data according to the combination of control factors in the process of collecting the inspection values, such as:

(a) product A & client 1 & equipment 01,

(b) product A & client 1 & equipment 02,

(c) product B & client 1 & equipment 01,

(d) product B & client 2 & equipment 01, and

(e) product B & client 2 & equipment 02.

Referring to FIG. 4, FIG. 4 is a flowchart describing a method of automatically collecting inspection information and corresponding to control charts according to the present invention. As seen, the automatic delaminating and corresponding of the inspection values to control charts according to the present invention comprises the steps of:

Step 411: Selecting quality control item;

Step 412: Inputting a ID of a specific inspection lot;

Step 413: Collecting contents of the associated lot factors;

Step 414: Querying the contents of quality control charts according to contents of control chart factors;

Step 415: Determining if a control chart exists;

Step 416: If not, generating a new control chart according to the contents of inspection lot's specification factors and default specifications set by the quality engineer;

Step 417: If yes, inputting inspection values;

Step 418: Performing control and analysis of the control chart; and

Step 419: Recording inspection information and data.

What is claimed is:

1. An on-line statistical process control information system, comprising:
a data setup module used for setting data of kinds desired;
an on-line data collection module configured for collecting quality control data from a plurality of inspection workstations involved in a manufacturing process of products through a computer network;
a quality control and analysis module adapted to analyze the collected quality control information and compare an analyzed result obtained from the analysis of the collected quality control information with at least a quality control chart in a database and correspond the compared quality control information to the quality control chart; and
the database used for storing the data of kinds desired being set, data associated with the analyzed quality control information and data associated with at least a control chart.

2. The system as recited in claim 1, wherein the data of kinds desired comprises data associated with clients, suppliers, staffs, product, equipment, user authorization information, definitions of control factors, inspection history, quality control items, defective causes codes, associates of causes of deficiency, associates of control factors, inspection workstations, associates of inspection workstations, control specifications, control regulations, control content, provisional control and acceptable quality level (AQL) and sampling plan.

3. The system as recited in claim 1, wherein the on-line data collection module collects the quality control data by either or both of being input through an operator and through a connection with a network.

4. The system as recited in claim 1, wherein the system generates a warning message if the analyzed result exceeds a prescribed control criterion, wherein the warning message is sent to the operator through an email.

5. An on-line statistical process control information method, comprising the steps of:
(a) Selecting quality control item;
(b) Inputting inspection lot ID;
(c) Collecting contents of the associated lot factors;
(d) Querying the contents of control chart according to contents of control chart factors;
(e) Determining if a control chart exists;
(f) If not, generating contents of a new control chart according to the contents of specification factors and specifications and automatic delaminating and corresponding of inspection information obtained previously to the control chart;
(g) If yes, inputting inspection values;
(h) Performing control and analysis of the control chart; and
(i) Recording inspection information and data.

6. The method as recited in claim 5, wherein the data of kinds desired comprises data associated with clients, suppliers, staffs, product, equipment, user authorization information, definitions of control factors, inspection history, quality control items, defective causes codes, associates of causes of deficiency, associates of control factors, inspection workstations, associates of inspection workstations, control specifications, control regulations, control content, provisional control and acceptable quality level (AQL) and sampling plan.

7. The method as recited in claim 5, wherein the inspection values are input by either or both of being input through an operator and through a connection with a network.

8. The method as recited in claim 5, further comprising a step of generating a warning message if an analyzed result obtained from the analysis of the control chart exceeds a prescribed control criterion, wherein the warning message is sent to the operator through an email.
